(19) United States
(12) Patent Application Publication
(10) Pub. No.: US 2003/0188155 A1
(43) Pub. Date: Oct. 2, 2003

(54) System and method of determining the number of central processing units for sizing a portal server

(76) Inventor: Patrick Petit, Grenoble (FR)

Correspondence Address: WAGNER, MURABITO & HAO LLP, Third Floor, Two North Market Street, San Jose, CA, 95113, US

(21) Appl. No.: 10/109,330

(22) Filed: Mar. 27, 2002

(51) Int. Cl. H04L 9/00

(52) U.S. Cl. 713/155

(57) ABSTRACT

In an enterprise portal server system having a server, a web-based central processing unit (CPU) sizing method and system. The CPU sizing system includes logic for determining primary performance metrics that may affect the performance of a portal server. The CPU sizing system further includes logic for gathering secondary sizing factors that may also impact the performance of the portal server. In one embodiment of the present invention, a maximum number of concurrent users that may connect to the portal server together with the average session time of user accesses to the portal server, the maximum desktop reloads of desktop connecting to the portal server and the maximum number of initial desktop displays are used to determine the optimal number of CPUs required for optimum performance which leads to maximum throughput for minimum transaction time of the portal server.

### CROSS REFERENCE TO RELATED APPLICATION

This application is related to Patrick Petit et al., co-filed U.S. patent application Ser. No.:, filed on ______, titled “SYSTEM AND METHOD OF DETERMINING THE NUMBER OF MEMORY FOR SIZING A PORTAL SERVER”, attorney docket No.: SUN/7220______/ACM/DKA. To the extent not repeated herein, the contents of this patent application are hereby incorporated herein by reference.

### FIELD OF THE INVENTION

The present claimed invention relates generally to the field of corporate enterprise portal server systems. More particularly, embodiments of the present claimed invention relate to sizing the performance of portal servers.

### BACKGROUND ART

The Internet has become a dominant vehicle for data communications with a vast collection of computing resources interconnected as a network from sites around the world. And with the growth of Internet usage has come a corresponding growth in the usage of Internet devices, wireless devices and services in ways different from the traditional uses of such devices.

The growing base of Internet users has become accustomed to readily accessing Internet-based services, which traditionally were restricted or limited to the “client/server” environment, at any time from any location. Accessibility of traditional business services and products over the Internet means enterprises need to adjust to new paradigms of business transaction.

Consequently, some organizations are, for example, implementing a variety of business resources and services. As businesses migrate to implementing numerous business applications on the Internet and web-based applications become pervasive in the enterprise business environment, businesses must find ways to protect their valuable resources and services over the Internet.

To achieve this, business are implementing several access authentication schemes in order to ascertain valid user access to such resources over the Internet. To access protected resources or services, users within a typical business enterprise environment must authenticate themselves to access web-based resources.

To facilitate these security measures, business organizations are making a transition from unsophisticated network infrastructure to a sophisticated network infrastructure. Additionally, portal services are becoming an essential part of today's network-centric computing infrastructure. In making such a transition, efficient management of services and resources offered by such intelligent networks become critical. Today, many organizations have mission critical applications for users and policies on individually configurable desktop machines. This time-consuming individual configuration process is unsuitable for enterprises and service providers seeking to create intelligent networks.

User management and policy based tools for managing services are becoming an important requisite for intelligent networks which should be capable of dynamically providing services. Furthermore, as businesses extend their intranet services to extranets to include suppliers, business partners, and customers, providing access control increases in size and complexity. Organizations responding to the rapidly changing conditions of today's business environments, need to simplify and automate the configuration and control of their services.

In making corporate services available to a large number of employees and customer base, security of the information provided by corporations become critical. As corporate security takes the forefront of corporate computing, the use of virtual private networks has become an indispensable part of corporate networks.

A virtual private network is a way to simulate a private network over a public network such as the Internet. The growth in the Internet and its popular information services, commonly known as the World Wide Web has led to a popularity in the use of corporate intranets. Internally, companies are running TCP/IP networks (intranets) pushing information to their internal web-sites using web browsers as a common collaborative tool.

VPNs can be used to expand the reach of an intranet. Since intranets are typically used to communicate proprietary information, a company may not want just anyone on the Internet to have access to the information. There may be cases, however, where the company may want far-off offices to share data and information or for remote users to be able to connect to the company's intranet with corporate users using the Internet as a means of connection.

The need to share data within and outside the company's internal network has also led to the popularity in community web-based applications or portals. These portals enable users to share community based data, applications, service, etc., within a company. The increasing using of such community based data sharing has led to the increasing use of portal servers that connect the variety of user base to the corporate intranet and the Internet.

Portal servers provide a secure way of connecting the corporate intranet to the Internet thereby reducing the fears that sensitive information might leave the corporate network. A portal server also provides users the ability to connect to a corporate intranet via the Internet using a web browser without the user having to reconfigure their computer. The ease in connecting to corporate intranets via the portal server has made portal servers very attractive to many corporate information systems decision makers.

FIG. 1 is a block diagram illustration of a portal server environment. The portal server environment depicted in FIG. 1 comprises an enterprise portal server 110, a public network (the Internet) 115, a corporate intranet 120, back-end resource servers 130-140 and client computers 145-150. In the environment depicted in FIG. 1, client users 145-150 can directly access each of applications residing in the portal server 110 via the Internet 115 if such users are at a remote location. Similarly client 155 can access the same applications on the portal server 110 via the internal corporate intranet 120. Access to applications in the portal server 110 is subject to the user being authenticated by each individual application.

In the environment depicted in FIG. 1, for the user to access protected resources or services, the user must authenticate. If the user authenticates successfully and if the user is authorized to access the resources, the user is given access to the resource. User access is subject to the user presenting a valid password specific to each application in order to access the particular application.

Since the portal server 110 may be accessed from a variety of venues (e.g., remotely or directly) the number of users accessing the portal server at any point in time can be very large. The number of users concurrently connecting or attempting to connect to the portal server 110, may impact the performance of the portal server 110. To ensure the optimal performance of the portal server 110, system administrators typically manually determine a way to increase the number of central processing units (CPU) in the portal server 110 to allow a larger connected user base. However, these manual CPU determination increases are done without any precise logic or formula to it. Thus, most of the CPU performance sizing of the portal server 110 are done on a manual trial and error basis. This can be an inefficient and ineffective way to improve the performance of the portal server 110.

### SUMMARY OF INVENTION

Accordingly, in order to prevent the undue performance burdens that current portal users frequently encounter as they remotely or directly access network applications from portal servers via the Internet or intranet, there should be a way to for system administrators to automatically determine certain performance metrics to enhance central processing unit sizing requirements of the portal server. There must also be a way to allow the user to access multiple applications in the portal server without experiencing performance delays due to a lack of appropriate performance metrics being implemented by the port server as a result of the ineffective and inefficient performance sizing methods.

As the number of business applications on the Internet increases, enterprise system users are looking for an easy and reliable way to access multiple applications in a web based application environment without the inefficiencies of the prior art. An Internet infrastructure system is needed that has extensibility capabilities to allow access authentication and authorization to web-based resources and services in a business enterprise environment. Further, a need exists for a system and method of tracking user access to network resources and application services in order to provide optimal server service within a business environment. A need further exists for “out-of-the-box” central processing sizing solutions to allow network system administrators to connect portal servers to existing corporate networks that have the capacity to support a large number of users without the attendant performance problems of the prior art. A need further exists for an improved and less costly device independent portal server system, which improves efficiency and provides access to web-based content to various users of different configurations without losing the embedded features designed for these devices.

What is described, in one embodiment, is a central processing unit (CPU) determining system and method having a portal server supporting a CPU sizing tool for determining the optimal number of CPUs to enhance the performance of the portal server. This system provides access to predetermined primary metrics and secondary resources and services in a corporate portal server system environment to generate the appropriate metrics to size the portal server. In one embodiment of the present invention, the portal server system includes an authentication service system that authenticates user access requests to the portal server. A user access request is typically directed to web-based software applications and services which may be specific to an organization or an entity. In one embodiment of the present invention, the authentication service system additionally includes a user agent policy system that sets user access policy to applications in the portal server.

The present invention further includes a session service that monitors a user's session after the user has been authenticated to access particular files or directories in the portal server. The session service provides the present invention the ability to bypass user re-authentication after the user has been initially authenticated and validated.

Embodiments of the present invention are directed to a system and a method for determining the optimal number of CPUs for enhancing the performance of the portal server in light of the number of concurrent users who connect to the portal server. The present invention uses primary sizing factors such as the maximum number of users that can connect to the portal server, the maximum number of concurrent users that may connect to the portal server at a particular point in time.

Embodiments of the present invention include a CPU sizing module that is implemented as part of the portal server modules in an enterprise server system environment. The CPU module includes logic that allows a system administrator determine the optimal number of CPUs to enhance the optimal performance of the portal server.

Embodiments of the present invention include a performance requirements assessment module. The performance requirements assessment module provides the primary performance sizing metrics required to determine the number of CPUs required by the portal server. The performance requirements assessment module gathers performance metrics such as the maximum number of connected users that may connect to the portal server.

Embodiments of the performance requirements assessment module of the present invention further include a concurrent user calculation module. The concurrent user calculation module calculates the maximum number of users that may concurrently connect to the portal server at any particular point in time and establishes a session during a user authentication sequence so that the user can be identified across different requests made to the server.

Embodiments of the present invention further include a secondary sizing factors assessment module. The secondary sizing factors assessment module gathers secondary factors that may affect the sizing of the portal server in determining the optimal number of CPUs the portal server may require. These secondary factors may include the desktop configuration of desktop or wireless computers that may connect to the portal server. The secondary sizing factors may further include desktop reload data that indicate the number of reloads that users connected to the portal server may perform.

Embodiments of the present invention further include a profile service module that is used to track a user's access profile to URLs in the server. Embodiments of the present invention also include a URL access service that uses an extensible markup language (XML) over a hypertext transport protocol (HTTP) interface of the authentication service and profile services, respectively, to validate a user's request.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

FIG. 1 is a block diagram of a portal server environment of the prior art;

FIG. 2 is a block diagram of one embodiment of the portal server environment of the present invention;

FIG. 3 is a block diagram of one embodiment of the portal server of the present invention;

FIG. 4 is a block diagram of an embodiment of the architecture of the central processing unit (CPU) determination tool system of the present invention;

FIG. 5 is a block diagram of one embodiment of the performance requirements assessment module of FIG. 4;

FIG. 6 is a block diagram of one embodiment of the secondary sizing factors assessment module of FIG. 4; and

FIG. 7 is a flow chart of an exemplary process flow implementation of a CPU sizing process of an embodiment of the present invention.

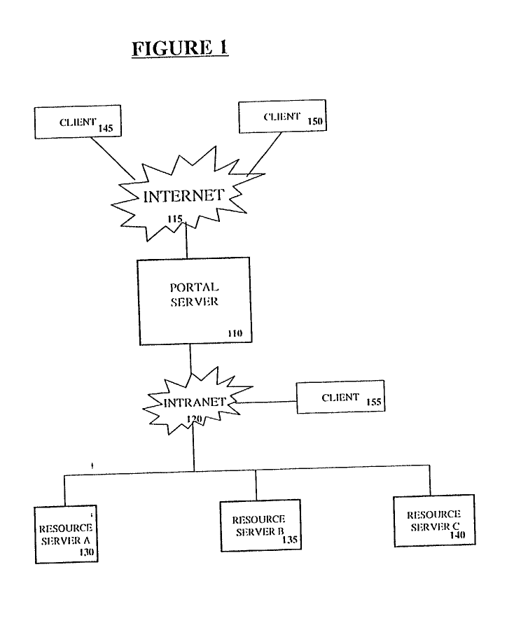

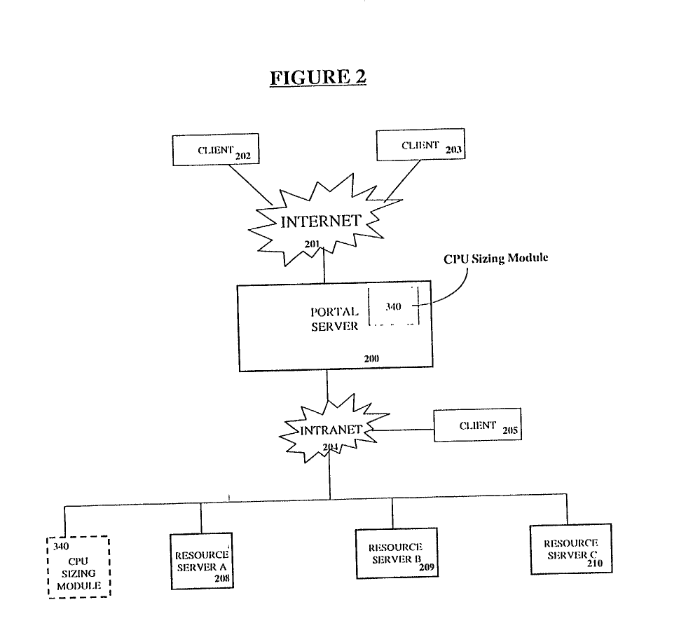

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

Embodiments of the invention are directed to a system, an architecture, subsystem and method to determine the optimal number of central processing units required by a portal server for optimum performance of maximum throughput with minimum transaction time in a way superior to the prior art.

In the following detailed description of the present invention, a system and method for an Internet protocol-based resource and applications access system are described. Numerous specific details are not set forth in order to provide a thorough understanding of the present invention. However, it will be recognized by one skilled in the art that the present invention may be practiced without these specific details or with equivalents thereof.

Generally, an aspect of the invention encompasses providing a central processing sizing unit which provides a method of determining the optimal number of central processing units a portal server may require during a portal server deployment in an enterprise network system.

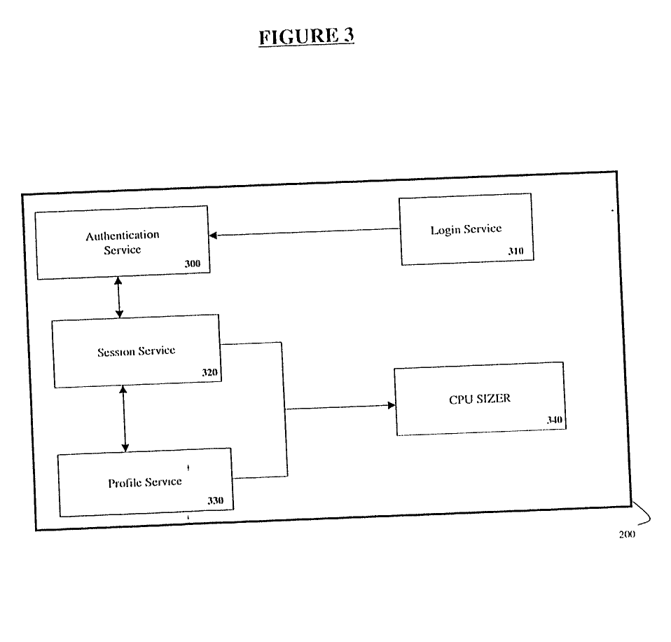

FIG. 2 is a block diagram illustration of a portal server environment. The portal server environment depicted in FIG. 2 comprises a portal server 200, a plurality of desktop or wireless clients 202 and 203 which are connected to the Internet 201, intranet 204, client 205 and back-end resource servers 208-210. In the environment depicted in FIG. 2, a user can directly access the portal server 200 either via the Internet 201 or the intranet 204. As further depicted in FIG. 2, the portal server 200 comprises a central processing unit sizing module 340 of the present invention. Access to URLs in applications on the portal server 200 is subject to the user being authenticated by the portal server 200. In one embodiment of the present invention, the CPU sizing module is coupled to the server 200 as an off-line resource that a system administrator may use to determine the CPU requirements of the server 200 prior to installation of the server 200.

In the environment depicted in FIG. 2, for the user to access protected resources or services, the user must authenticate. If the user authenticates successfully and if the user is authorized to access the resources, the user is given access to the resource. Content provided by the portal server 200 may include content aggregated from the back-end resource servers 208-210. In the environment shown in FIG. 2, the portal server 200 tracks the initial desktop displays after the client has authenticated to the portal server 200 and the desktop reloads in order to generate the right metrics to measure the throughput of the portal server 200.

FIG. 3 is a block diagram depiction of one embodiment of the portal server 200 of the present invention. In the exemplary diagram shown in FIG. 3, the portal server 200 comprises authentication module 300, login module 310, session module 320, profile module 330 and CPU sizing module 340.

The authentication module 300 provides sign on service authentication of the present invention. The authentication module 300 provides the portal server 200 (FIG. 2) with the logic and option to protect Internet software applications and services from unauthorized authenticated users of these applications.

The authentication module 300 of FIG. 3 further provides the portal server 200 with the access implementation logic to selectively allow access to specified applications and services within enterprise organizations. By selectively allowing only authorized and authenticated users access to particular files within an organizations file database, the authentication module 300 ensures that corporate enterprise resources are efficiently and effectively utilized.

Further, the authentication module 300 allows authenticated users of the portal server 200 continuous and uninterrupted use of resources and applications available on the server 200. This enables the sizing logic of the present invention to accurately determine the number of users that are connected to the portal server 200 at any time.

The login module 310 provides login services to the portal server 200. Login module 310 includes logic to enable the tracking of a user's password to enable the sign-on services of the authentication process to function in the server 200.

Still referring to FIG. 3, the session module 320 provides a session tracking mechanism to enable the authentication logic of the present invention to track a user's login session to the portal server 200. The session module 320 logs the user's access of each application for which the user is authenticated to access. By logging the user's access to applications on the portal server 200, the authentication module is able to automatically authenticate the user's access to subsequent applications, after the initial login, without requiring a separate manual re-login.

The profile module 330 provides user profile information to the authentication module 300. The profile module 330 provides an XML over http(s) interface for obtaining user, service and policy information. A user's profile information typically includes the user-name, the user's password and, the user's entity within a particular organization.

The profile information further defines the user's application access rights which determine or set forth user's rights to files and directory within applications and resources in portal server 200.

The CPU sizing module 340 is coupled to provide the CPU sizing process of the present invention. The CPU sizing module 340 includes logic to monitor the number of users connected to the portal server 200, the maximum number of concurrent users connected to the portal server 200 and other secondary factors associated with the clients desktops connected to the portal server 200 to determine performance metrics to enhance the performance of the portal server 200. The CPU sizing module 340 provides a mechanism by which a system administrator can determine the number of CPUs a particular portal server may need to provide an efficient and effective utilization of the underlying portal resources by the users connected to the portal server 200.

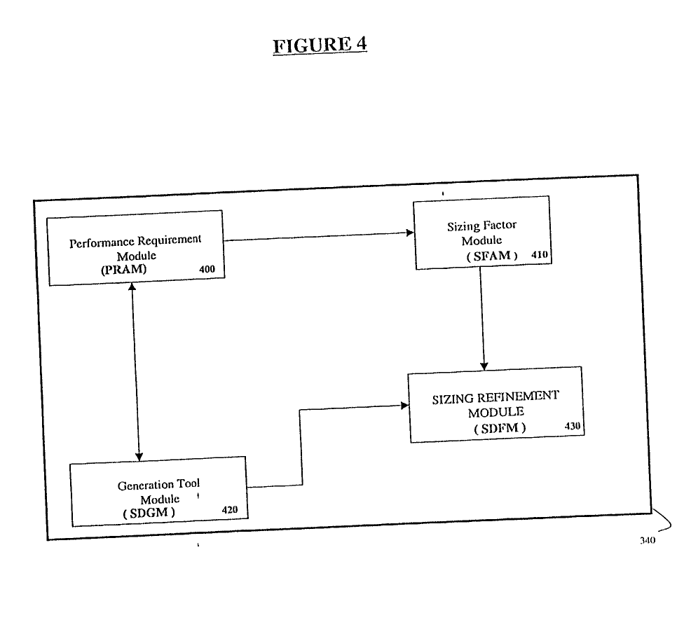

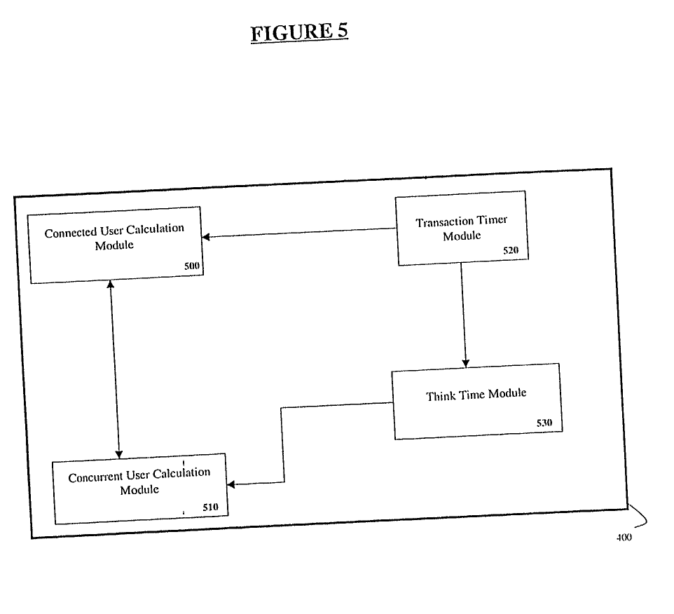

FIG. 4 is a block diagram illustration of an internal architecture of one embodiment of the CPU sizing module 340 of the present invention. As shown in FIG. 4, the CPU sizing module 340 comprises performance requirements assessment module (PRAM) 400, secondary factors sizing assessment module (SFAM) 410, sizing data generation module (SDGM) 420 and sizing data refinement module (SDFM) 430. In order to determine the CPU sizing requirements of the portal server 200, the CPU sizing module 340 executes in sequence the sizing modules depicted in FIG. 4 to best determine the number of CPUs for a specific deployment of the portal server 200.

To accomplish the sizing process of the present invention, the CPU sizing module 340 initiates a performance requirement data gathering process by activating PRAM 400 to gather and assess the data metrics provided by a system administrator in light of the computing environment of the particular portal server. The data provided by the system administrator enables the PRAM 400 generate the correct formulation of the maximum number of users that may connect to the portal server 200 and the maximum number of concurrent users who may connect to the portal server 200 at any given time.

SFAM 410 provides the PRAM 400 with secondary data that may factor into the performance metrics that PRAM 400 generates and assesses to determine the optimal number of CPUs the portal server 200 may require. SFAM 410 gathers and assesses secondary performance metrics that may be required by the portal server 200 to complete the sizing process of the present invention.

Among the secondary factor metrics that SFAM 410 may gather and assess include the desktop configuration of the users who may connect to the portal server 200, the specific customization metrics, if any, of a particular portal server, the average session times that users login into the portal server and, the server hardware and applications configurations that may affect the performance of the portal server. The speed and efficiency parameters of the back-end resources servers 208-210 that connect to the portal server 200 are also gathered and assessed by SFAM 410. The data gathered by SFAM 410 are used as inputs in the sizing process by CPU sizing module 340.

Still referring to FIG. 4, the SDFM 430 provides a pilot representation data of the final portal server application in order to validate and refine the sizing numbers obtained in an initial run of the sizing process of the present invention. Since performance and resource consumption vary greatly in a particular portal server depending on the complexity of the connecting desktops and usage profile, the CPU sizing process of the present invention provides a mechanism for the system administrator to generate a sample (pilot) of the contemplated sizing metrics of a portal server being sized before fully implementing the CPU sizing module 340.

The SDFM 430 implements a representative subset of the portal applications that typically will run on portal server 200 by integrating back-end services of the back-end resource server 208-210 to generate a subset of the projected number of CPUs that may be obtained during a full implementation of the sizing process. The numbers from the pilot performance test using the pilot numbers provided by the SDFM 430 is re-injected into the CPU sizing module 340 to obtain a more accurate result during a full implementation of the sizing metrics gathered by the CPU sizing module 340.

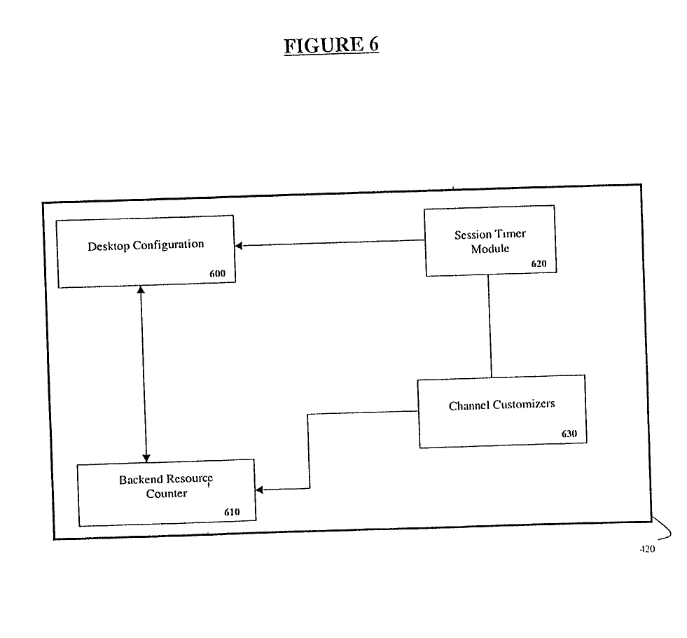

FIG. 5 is block diagram depiction of one embodiment of the performance requirement assessment module 400 of the present invention. The performance requirement assessment module 400, as shown in FIG. 5, comprises a connected user calculation module 500, a concurrent user counter 510, transaction timer module 520 and a think time module 530.

The connected user calculation module 500 calculates the maximum number of users or sessions connected to the portal server 200. A connected user is a user who has a valid portal session open, but who may not be active at a certain time. The maximum number of users is generally a percentage of the user base that can be obtained from different sources, such as usage statistics or web traffic analysis for an already existing portal or web application.

The web traffic metric representing the best value to calculate the maximum number of connected users is often called visitor sessions (e.g., a single visitor visit within a predefined period of time). Depending on the portal audience and portal type (e.g., business to employee or business to customer portal), that percentage can vary from a fraction of the user base to the entire user base. For example, in a corporate environment, the total user base may be based on the number of active employees, not including employees that are either on the road, on vacation, or are out sick.

In the present invention, another variable that needs to be considered to calculate the maximum number of connected users by the connected user calculation module 500 is whether the maximum number of users calculated were calculated based on regular or peak server load conditions. The periodicity and amplitude of the peaks of load can substantially vary over time, but once they have been identified, the resulting number of connected users tends to be relatively steady for the observed period.

The concurrent user calculation module 510 is coupled to the connected user calculation module 500 to calculate the maximum number of concurrent users connected to the portal server 200 at any point in time. In one embodiment of the present invention, to calculate the maximum number of concurrent users, the concurrent user calculation module 510 uses a user interactivity profile to determine the number of users connected to the portal server 200. The user interactivity profile defines the number of hits registered to the portal server 200 per unit of time called the reference time period.

The reference time period is typically one minute. However, the reference time period could be more or less than one minute. Once established, the reference time period has to be revised consistently throughout the sizing calculation process. For example, a user clicking on the desktop every 15 minutes on the average has an interactivity profile of 1/15 if the reference time period chosen is one minute.

For accuracy in the results in the sizing process, it is important that the reference time period represents the smallest unit of time during which a user cannot issue more than one request to the portal server 200. The user interactivity profile can be noted as a mathematical expression 1/N, where N is the number of reference time periods between two hits on the average. An interactivity profile of 1/1 is considered maximum and physically represents users continuously accessing the desktop at a maximum rate humanly possible. The user interactivity profile is driven by as many arbitrary factors such as the session time, desktop type and user think time.

The user think time module 530 is coupled to calculate the user think time. The user think time defines the time elapsed between desktop clicks resulting in HTTP operations to the portal server 200 as opposed to the external resource servers 208-210. From the portal server's perspective, the think time could be anything from the time taken by the user to enter the user's authentication credentials, the time taken by the user to read a portal page or even the user's session or idle time-out if the user walks away from his desktop for an extended period of time. The think time then amounts to idle times for the portal server 200 and it equivalent to no user at all except until the session is terminated (logout or session time-out).

Still referring to FIG. 5, the transaction timer module 520 is coupled to the connected user calculation module 500 and the think time module 530 to determine the transaction time for a user to complete an operation. The transaction time is the delay taken for an HTTP or HTTP(s) operation to complete. The metric gathered from this includes the aggregated send time, processing time and response time sub-metric. Depending on a browser's connection, speed, send time and response time delay may vary.

Typically, a response time delay will be longer with a connection speed of about 33.6 Kps than with a LAN connection speed. However, the processing time remains constant. The portal server 200 is timed so that the processing time under regular or peak load conditions do not exceed a certain threshold as far the performance requirements is concerned.

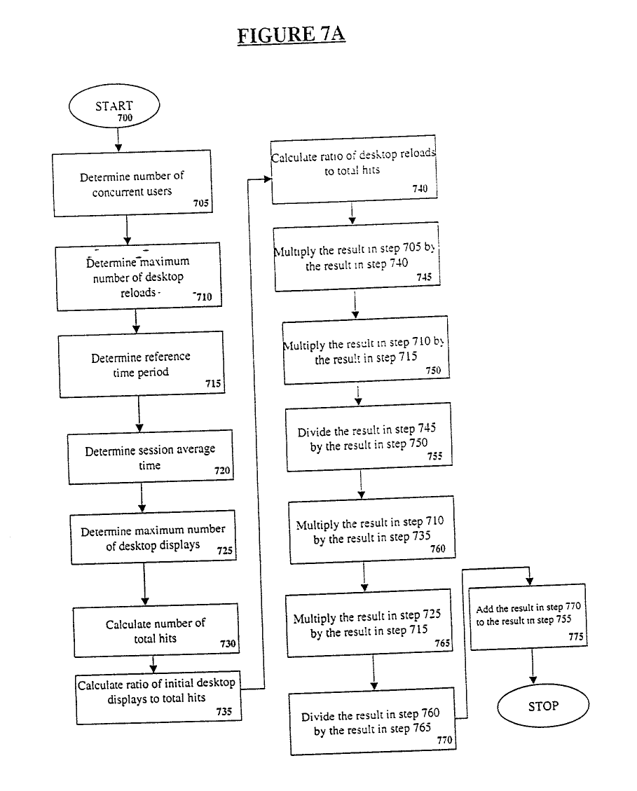

FIG. 6 is a block illustration of one embodiment of the secondary sizing factors assessment module 420 of the present invention. As shown in FIG. 6, the secondary factors sizing module 420 comprises desktop configuration analysis module 600, back-end resources counter module 610, session timer module 620 and desktop channel customization assessment module 630.

The desktop configuration analysis module 600 drives the explicit amount of data held in memory on a per user session basis. The more channels that a particular desktop has, the bigger the size of the session data and the lesser the throughput of the portal server 200. The desktop configuration module 600 also monitors the amount of interactivity of the desktop to help determine the sizing requirements of the portal server 200.

The back-end resource counter module 610 is coupled to the desktop configuration module 600 to determine the speed and efficiency of the back-end servers. The portal server 200 aggregates content from external sources such as the back-end servers and makes the aggregated content available to users connecting to the portal server. It is appreciated that if the external content providers cannot sustain the necessary bandwidth for the portal server 200 to operate efficiently, the delay for desktop rendering will not be optimum, as well as the request throughput, since the desktop waits until all channels are completed (or timed out) before returning the request response to the user's browser.

The session timer module 620 provides the average session time for a given number of concurrent users. The session timer module 620 drives the number of logins per second that the portal server 200 will have to sustain. The longer the session-duration, the less logins per second are generated against the portal server 200 for the same concurrent user base. The average session time is a very important parameter used by the sizing process of the present invention to determine the CPU requirements of the portal server 200.

The desktop channel customization module 630 provides channel customization parameters that affect the performance of the portal server 200. Since desktop customization parameters may be outside the control of the system administrator of the portal server 200, it is important for these parameters to be gathered and analyzed during the pilot test performance phase of the present invention in order not to skew the final numbers of the CPU sizing module.

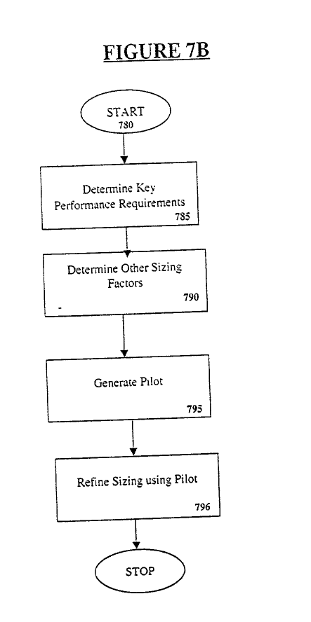

FIG. 7 represents a flow diagram depiction of an exemplary computer implemented process in accordance with one embodiment of the CPU sizing processing of the present invention. The steps performed by the diagram of FIG. 7 are performed by a computer processor executing memory stored instructions which make up a program or application. The number of CPUs in the portal server 200 is primary determined by the number of HTTP operations (or transactions) generated by all the concurrent users per unit of time. Typically HTTP operations to the portal server 200 are a mix of get and post requests to the underlying servlet engines for creating portal sessions, initializing desktops and desktop reloads, or simply to static HTML and GIF files.

As shown in FIG. 7A, the process of determining the number of portal server 200 CPUs is initiated at step 700 when a system administrator's sizing request is presented to the CPU sizing module 350. At step 705, the CPU sizing module determines 350 determines the average number of concurrent user of the portal server 200. This number is obtained from the performance requirements module 400.

At step 710, the CPU sizing module 350 determines the maximum number of desktop reload per second obtained from the performance results. The desktop reloads involves the operation of activating the reload button of a browser on a desktop or clicking through tabs on the desktop, if any. Knowing the maximum reloads enables the sizing process to measure the throughput of the portal server 200. In one embodiment of the present invention, the maximum number of desktop reloads may be a constant.

At step 715, the CPU sizing module 350 determines the reference time period from projected user activity in the portal server 200. The reference time period is expressed in seconds and it is obtained from the performance requirements analysis and assessment module 400.

At step 720, the CPU sizing module 350 determines the average time of each user session in the portal server 200. The average user session time is provided by the secondary factors sizing module 410. And the average session time is expressed in minutes.

At step 725, the CPU sizing module 350 determine the maximum number of initial desktop displays to the portal server 200. The initial desktop typically generates the highest overhead in the portal server 200. Initial desktop displays follow session creation regardless of whether a user authenticates or not. Session creation and the initial desktop display generate a bulk of the portal server 200 requests to the profile and session modules. The maximum desktop display in combination with the desktop reloads metrics provide the basis for the sizing process of the present invention to measure the through-put of the portal server 200.

At step 730, the CPU sizing module 350 calculates the number of total hits that a system administrators anticipates in the portal server 200. In one embodiment of the present invention, the total number of hits is calculated by determining the total number of users and determining the number of hits per each user session. The result of the two is added to yield the total number of hits.

At step 735, the CPU sizing module 350 calculates the ratio of initial desktop displays to the total number of hits. In one embodiment of the present invention, the ratio of initial desktop hits is the quotient of one divided by the number of hits per session.

At step 740, the CPU sizing module 350 calculates the ratio of desktop reloads to the total number of hits. The ratio of the desktop reloads is the quotient of the number of hits per session minus one, divided by the number of hits per second.

At step 745 of FIG. 7A, the results of the number of concurrent users is multiplied by the quotient of the ration of the desktop reloads to the total number of hits in step 740.

At step 750, the maximum number of desktop reloads per second in step 710 is multiplied by the result of the reference time period in step 715.

At step 755, the results of step 745 is divided by the result in step 750. And at step 760, the result at step 710 is multiplied by the result of step 735.

At step 765, the results of step 725 is multiplied by the result in step 715. And in step 770, the result in step 760 is divided by the result in step 765. The result in step 770 is added to the result in step 755 to obtained the number of CPUs.

To determine the optimum number of CPUs that the portal server 200 may require, the results of step 770 are added to the result of step 792. The current CPU sizing of one embodiment of the present invention may thus be expressed by the following exemplary formula expression:

#cpu=((cru*drratio)/(drs*rtp))+((cru*iddratio)/(ids*rtp))

where:

cru:—is the maximum number of concurrent users;

drs:—is the maximum number of desktop reloads per second;

rtp:—is the reference time period expressed in seconds;

ids:—is the maximum number of initial desktop displays per seconds;

iddratio: is the ratio of initial displays to total hits ratio; and

ddratio: is the desktop reloads to total hits ratio.

FIG. 7B is a flow diagram of one embodiment of the sizing process of the present invention. The sizing process in FIG. 7B is discussed with reference to FIG. 4. In one embodiment of the present invention, the sizing process requires four steps to determine the best sizing estimate for a specific portal server deployment. In one embodiment of the present invention, a system administrator may conduct the sizing process “off-line” to the portal server being deployed.

The sizing process starts at step 780. At step 785, the system administrator determines the key performance requirements for the portal server. These performance requirements as discussed in FIG. 4 includes the maximum number of connected users, the maximum number of concurrent users and the transaction time.

At step 790, the system administrator determines secondary factors that might affect the performance of the portal server. These secondary factors may include the desktop configuration, custom channels and other modules that may affect the performance of the portal server, the average session time for a given number of concurrent users, the speed and efficiency of back-end resources.

At step 795, the system administrator generates a recommendation sample of the metrics required by the portal server being deployed by using the CPU sizing module 340 to generate the number of CPUs that might be required for optimal performance of the portal server. And at step 796, the results from the from the sizing module 340 is used to generate a pilot metrics for the portal server being deployed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A portal server, comprising:
an authentication module for authenticating user credentials for users attempting to connect to said portal server;
a session module coupled to said authentication module to monitor authenticated user access to said portal server;
a profile module coupled to said session module to store user profile information for user successfully authenticating to said portal server; and
a central processing unit sizing module for determining the optimal number of central processing units required by said portal server for optimum performance.

2. The portal server of claim 1, wherein said central processing unit sizing module comprises a performance requirement assessment and analysis module for gathering performance measurement metrics to measure the optimum performance of said portal server.

3. The portal server of claim 2, wherein said performance requirements assessment and analysis module further comprises a connected user calculation module for calculating the maximum number of concurrent users that may connect to the portal server.

4. The portal server of claim 3, wherein said connected user calculation module further calculates the maximum number of concurrent sessions of user sessions in said portal server.

5. The portal server of claim 4, wherein said performance requirements assessment and analysis module further comprises a concurrent user counter module for calculating the maximum number of concurrent users that connect to the portal server at any given time.

6. The portal server of claim 5, wherein said concurrent user calculation module further calculates a user interactivity profile that reflects the number of hits said user registers to said portal server during a reference time period.

7. The portal server of claim 6, wherein said reference time period is one minute.

8. The portal server of claim 4, wherein said CPU sizing module further comprises a secondary sizing factors assessment module for gathering secondary sizing factor metrics used in determining the performance metrics of said portal server.

9. The portal server of claim 8, wherein said secondary sizing factors module comprises a desktop configuration analysis module for determining the configuration metrics of desktops connecting to said portal server.

10. The portal server of claim 9, wherein said secondary factors sizing module further comprises a back-end resource counting module for gathering speed and efficiency metrics of back-end resource servers connected to said portal server.

11. The portal server of claim 10, wherein said secondary sizing factors calculation module further comprises a session timing module for determining the average session time for logins per second of a given number of concurrent users connected to said portal server.

12. The portal server of claim 8, wherein said secondary sizing factors calculation module further comprises a desktop customization assessment module for identifying channel customization metrics that affect the performance of said portal server.

13. The portal server of claim 12, wherein said CPU sizing module further comprises logic to generate a subset of performance test metrics for said portal server during a pilot test performance phase of a CPU sizing process of the CPU sizing module.

14. A central processing unit (CPU) sizing unit for determining optimal number of CPUs in a portal server, comprising:
A performance requirement assessment and analysis module for gathering performance measurement metrics to measure the optimum performance of said portal server;
a connected user calculation module for calculating the maximum number of concurrent users that may connect to the portal server; and
a data sizing refinement module for generating a subset of the sizing data required to generate said optimal number of CPUs for the portal server during a test performance phase.

15. The CPU sizing unit of claim 14, wherein said performance requirements assessment and analysis module comprises a concurrent user counter module for calculating the maximum number of concurrent users that connect to the portal server at any given point in time.

16. The CPU sizing unit of claim 15, wherein said concurrent user calculation module further calculates a user interactivity profile that reflects the number of hits said user registers to said portal server during a reference time period.

17. The CPU sizing unit of claim 16, wherein said reference time period is one minute.

18. The CPU sizing unit of claim 17, further comprising a secondary sizing factors assessment module for gathering secondary sizing factor metrics used in determining the performance metrics of said portal server.

19. The CPU sizing unit of claim 18, wherein said secondary sizing factors module comprises a desktop configuration analysis module for determining the configuration metrics of desktops connecting to said portal server.

20. The CPU sizing unit of claim 19, wherein said secondary sizing factors module comprises a desktop configuration analysis module for determining the configuration metrics of desktops connecting to said portal server.

21. The CPU sizing unit of claim 20, wherein said secondary factors sizing module further comprises a back-end resource counting module for gathering speed and efficiency metrics of back-end resource servers connected to said portal server.

22. The CPU sizing unit of claim 19, wherein said secondary sizing factors calculation module further comprises a session timing module for determining the average session time for logins per second of a given number of concurrent users connected to said portal server.

23. The CPU sizing unit of claim 22, wherein said secondary sizing factors calculation module further comprises a desktop customization assessment module for identifying channel customization metrics that affect the performance of said portal server.

24. The CPU sizing unit of claim 22, wherein said CPU sizing module further comprises logic to generate a subset of performance test metrics for said portal server during said test performance phase of a CPU sizing process of the CPU sizing module.

25. A method of sizing an optimal number of central processing units for a portal server, comprising:
determining the maximum average number of concurrent users that may connect to said portal server;
determining number of desktop reloads of desktops that may connect to said portal server;
determining the reference time period for projected user activity in said portal server;
determining the maximum number of initial desktop reloads of desktops connected to said portal server;
determining the average time of user sessions in said portal server;
calculating a ratio of the number of desktop reloads to the number of hits for said portal server;
calculating a ratio for the initial desktop displays to the number of total hits for said portal server; and
calculating an optimal number of central processing units for said portal server.

26. The method of claim 25, wherein said calculating said optimal number of central processing units comprises a first multiplication step of multiplying said maximum average number of concurrent user by ratio of desktop reloads to the number of total hits.

27. The method of claim 26, wherein said calculating said optimal number of central processing units further comprise a second multiplication step of multiplying said maximum number of desktop reloads with said reference time period.

28. The method of claim 27, wherein said calculating said optimal number of central processing units further comprises a first quotient determination step of dividing said first multiplication step by the result of said second multiplication step.

29. The method of claim 28, wherein said calculating said optimal number of central processing units further comprises a third multiplication step of multiplying said maximum average number of concurrent users by said ratio of initial desktop displays to total number of hits.

30. The method of claim 29, wherein said calculating said optimal number of central processing units further comprises a fourth multiplication step of multiplying said maximum number of desktop displays by said reference time period.

31. The method of claim 30, wherein said calculating said optimal number of central processing units further comprises a second quotient determining step of dividing said third multiplication step by said fourth multiplication step.

32. The method of claim 31, wherein said calculating said optimal number of central processing units further comprises determining the sum of said second quotient determining step and the result of said first quotient determining step.
